(19) United States
(12) Patent Application Publication
(10) Pub. No.: US 2008/0294665 A1
(43) Pub. Date: Nov. 27, 2008

(54) Methods and Systems for Handling Data in a Storage Area Network

(75) Inventors: Eric Bursley, Pflugerville, TX (US); Jacob Sims, Puyallup, WA (US); Vincent E. Valdez, Elgin, TX (US)

Correspondence Address: ANDREA E. TRAN;PRAMUDJI WENDT & TRAN, LLP, 1800 BERING DRIVE, SUITE 540, HOUSTON, TX, 77057, US

(73) Assignee: Dell Products L.P., Round Rock, TX (US)

(21) Appl. No.: 11/753,573

(22) Filed: May 25, 2007

(51) Int. Cl. G06F 17/30

(52) U.S. Cl. 707/101; 707/E17.044

(57) ABSTRACT

A method for handling data within a storage area network (SAN), the method comprising receiving by an information handling system, the data from a component of the SAN, the data associated with at least one configuration of the component, converting the data into processed data and providing the processed data to a database.

### BACKGROUND

1. Technical Field

The present disclosure relates generally to information handling systems. In particular, but without limitation, the disclosure relates to storage area networks (SANs).

2. Background Information

As the value and use of information continues to increase, individuals and businesses seek additional ways to process and store information. One option available to users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems (IHS) in enterprise storage systems may be interconnected with storage apparatus in a SAN. A SAN is a popular network type for large enterprises because it allows multiple IHSs to access any storage device in the network, which tends to increase storage capacity utilization.

Though a SAN simplifies storage administration, frequent maintenance may be still required. Such maintenance may be provided by a network manager or engineer from the SAN vendor. To more efficiently determine the needs and problems of a particular storage area network, a network engineer would need to understand the network configuration and storage solution history. A history of storage solutions, which can include information on initial installation, upgrades, or technical support services, would enable the network engineer to more easily understand the history and configuration of a SAN. This may allow for a more accurate determination of upgraded installations or field replacements the SAN would need, or potential problems the SAN could have. Furthermore, when a business or customer desires to install a SAN upgrade, the storage configuration should be understood in order to select a compatible upgrade.

However, information on the configuration and storage solution history of a SAN may not always be readily available. Modifications to the storage configuration after installation or incomplete manual records of storage solution histories may present difficulties in understanding the SAN configuration and history, which can be problematic when a network engineer needs to provide upgrades or technical support for the SAN. Without the needed information, a network engineer would find difficulty troubleshooting or optimizing the storage solution configuration.

Creating methods and systems to process, view and store SAN configuration and storage solution history would enable a network engineer to understand the SAN even in the situations where storage configurations have been modified or previous storage solution records are incomplete. They also allow engineers, design architects, account teams, project manager, and any other persons involved in the development of the SAN to quickly understand a customer's storage configuration.

### SUMMARY

The following presents a general summary of some of the many possible aspects, implementations and/or embodiments of this disclosure in order to provide a basic understanding of the disclosure. This summary is not an extensive overview of all aspects, implementations and/or embodiments of the present disclosure. This summary is not intended to identify key or critical elements of the disclosure or to delineate or otherwise limit the scope of the claims. The following summary merely presents some concepts of the disclosure in a general form as a prelude to the more detailed description that follows.

In one aspects the present disclosure provides a method for handling data within a storage area network (SAN). The method may include receiving, by an information handling system, data from a component of the SAN, the data associated with at least one configuration of the component. The method may also include converting the data into processed data and providing the processed data to a database.

In another aspect, the present disclosure provides a system for handling data in a storage area network (SAN) wherein the system may include a component of a SAN, a first program of instructions comprising a first instruction to process the data associated with at least one configuration of the component of the SAN into processed data and a database operable to receive the processed data associated with the at least one configuration of the component.

In another non-limiting aspect, the present disclosure provides a computer-readable medium having executable instructions for performing a method. The method may include receiving, by an information handling system, the data from a component of the SAN, the data associated with at least one configuration of the component, converting the data into processed data and providing the processed data to a database.

### BRIEF DESCRIPTION OF THE DRAWINGS

The following drawings illustrate some of the many possible aspects, implementations and/or embodiments of this disclosure in order to provide a basic understanding of this disclosure. These drawings do not provide an extensive overview of all aspects, implementations and/or embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 illustrates one implementation of a system according to the present disclosure.

FIG. 2 illustrates one implementation of a method for handling data in a storage area network (SAN).

FIG. 3 illustrates one implementation of a method for upgrading an existing SAN configuration.

FIG. 4 illustrates one implementation of a method for installing a SAN.

FIG. 5 illustrates one implementation of a method for upgrading an existing SAN configuration stored in a vendor's database.

### DETAILED DESCRIPTION

For purposes of this disclosure an embodiment of an Information Handling System (IHS) may include any instrumentality or aggregate of instrumentalities operable to compute, classify, process, transmit receive, retrieve, originate, switch, store, display, manifest, detect, record, reproduce, handle, or utilize any form of information, intelligence, or data for business, scientific, control, or other purposes. For example, an IHS may be a personal computer, a network storage device, or any other suitable device and may vary in size, shape, performance, functionality, and price. The IHS may include random access memory (RAM), one or more processing resources such as a central processing unit (CPU) or hardware or software control logic ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to transmit data communications between the various hardware components.

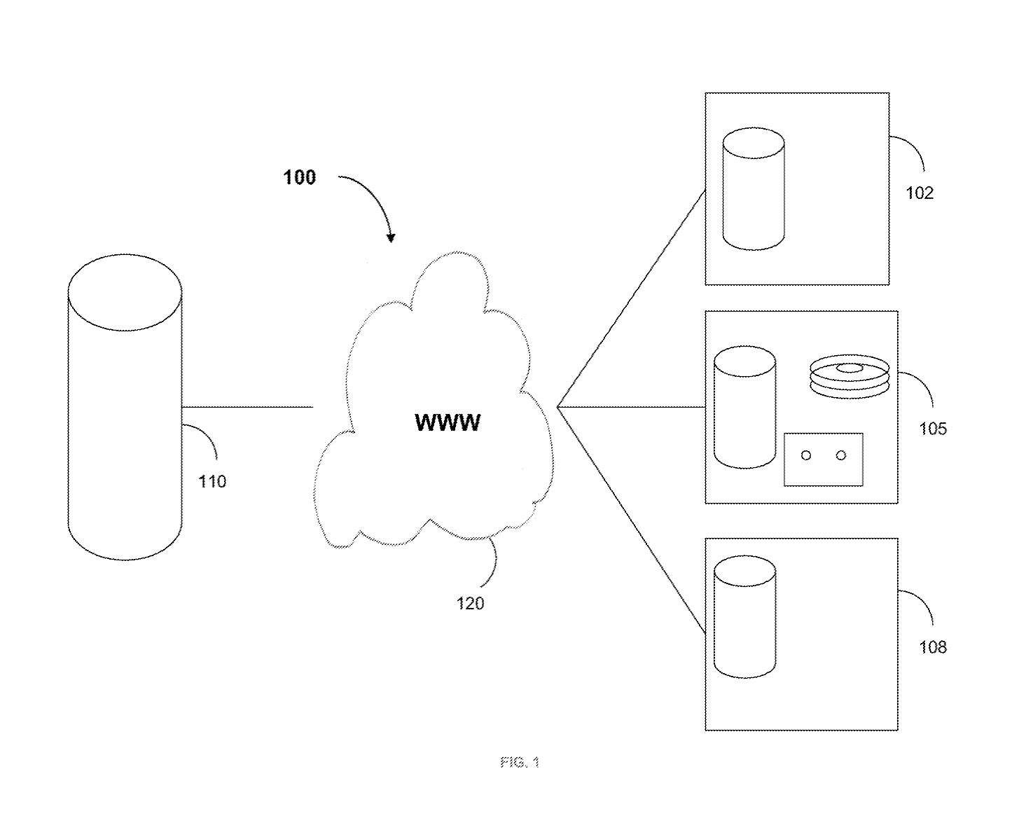

Now referring to FIG. 1 which shows a system indicated generally at 100, according to the present disclosure. The system 100 includes a plurality of storage area network (SAN) components indicated at 102, 105 and 108. A component of the SAN may include but is not limited to a server, switch, disk array and tape library. Alternatively, a component of the SAN may include an additional component or network device suitable to be included within a SAN. The components of the SAN may belong to several different customers or users and can be at various locations. The vendor's database 110 stores at least one configuration (i.e., current and past) of each customer's SAN following the processing of the configuration data by an application or program 120. These stored configurations allow the vendor to provide service to the customers.

A software program 120 may receive data associated with a possible configuration of at least one SAN component. Another software program (not shown) may further process and or parse the data prior to providing the data to a database (i.e., vendor database). In one aspect, the program may process the data so that the configuration or hierarchical infrastructure of at least one SAN component may be provided to the database in a form receivable by the database. The processed data provided to the database may be in a form receivable by the database, which may include, but is not limited to, data in object code. In illustrative implementations, the parsed data may comprise an infrastructure of configurations wherein the storage area network may be represented by a host at the top layer further followed by a switch and a tape library.

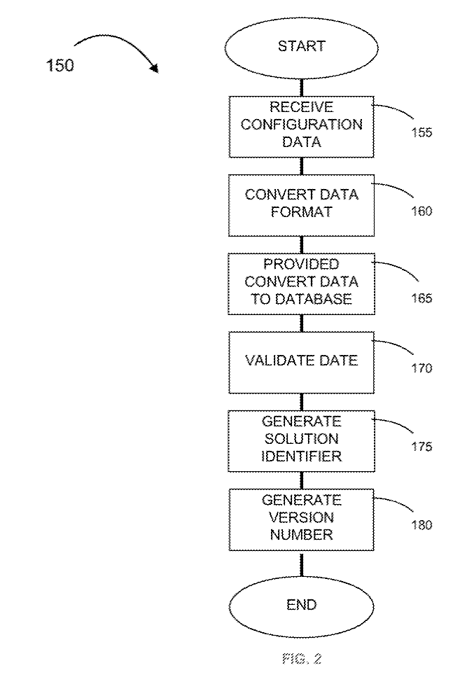

As illustrated in FIG. 2, a flow diagram depicting one implementation of a method 150 for handling data within a SAN. Various methods are contemplated comprising all or less than all of the steps shown in the FIG. 2 and described herein, any number of repeats of any of the steps shown, and in any order. The method 150 may include the step 155 of receiving configuration data from a component of the SAN. In illustrative implementations, the configuration data may be associated with the configuration of a newly installed SAN component, the configuration of a system with removed SAN components, the configuration of an upgraded SAN or the like. The configuration data received by the IHS may include any representation of the configuration of any component or group of components in a SAN. This presentation may exist in any suitable form including but not limited to source or object code. The method 150 may further include step 160 wherein the data received is converted into a format (e.g., processed data) that may be provided to a database in step 165 to be accessed by a user and/or vendor. In step 170, the configuration data may be validated by a user to ensure that the solution contains complete data or that the data received is can generate a valid system quote from the vendor. Furthermore, the configuration data may be validated to ensure the SAN is within supported guidelines as provided by the vendor.

Continuing with FIG. 2, a solution identifier is generated and provided to the database in step 175. The database may provide searchability of configuration data based on the solution identifier. In one implementation, the solution identifier combines the SAN configuration data with a first identifier (e.g., serial number) associated with every device and/or SAN component. In step 180, a version number is generated and associated with the solution identifier. The version number may include an indicator of the date and time when configuration data is captured and uploaded into the database. In an illustrative implementation, a solution identifier may have at least one associated version number indicative of the date and time of each database upload.

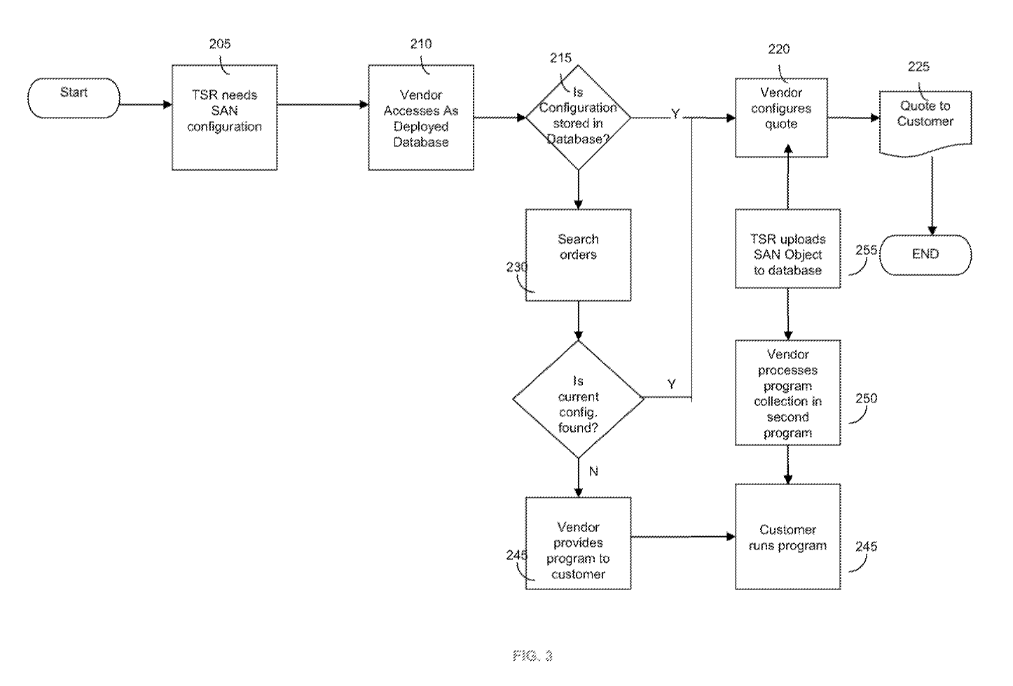

Shown in FIG. 3 is a flow diagram of one implementation of a method for upgrading an existing SAN configuration. A user and/or vendor may need the current SAN configuration 205 in order to provide a validated upgrade to the SAN. When a SAN user requests an upgrade or any other service requiring the current SAN configuration data, the user may access the database 210 to confirm if the SAN configuration was stored in the database 215 from a previous deployment or the like. If the SAN configuration is stored in the database, then an upgrade or service to the SAN 220 may be quickly configured and a quote may be provided to the user 225.

However, if the SAN configuration is not stored in the database, then the vendor will need to perform several steps to determine the SAN configuration. The steps taken if the SAN configuration is not stored in the database may take several days to perform, as opposed to the quick quote that may be provided to the customer if the SAN configuration is stored in the database. The vendor will typically search for past orders by the customer 230. If the current configuration is not found, the vendor will then provide a data collection program to the customer 240 that the customer will run 245 to capture the configuration of the customer's SAN. The results of the of the data collection program are then provided to the vendor who processes the results in a SAN object program 250. Finally, a SAN object generated by the SAN object program is uploaded into the database 255, which will allow the vendor to configure an upgrade to the SAN 220 and provide a quote to the customer 225.

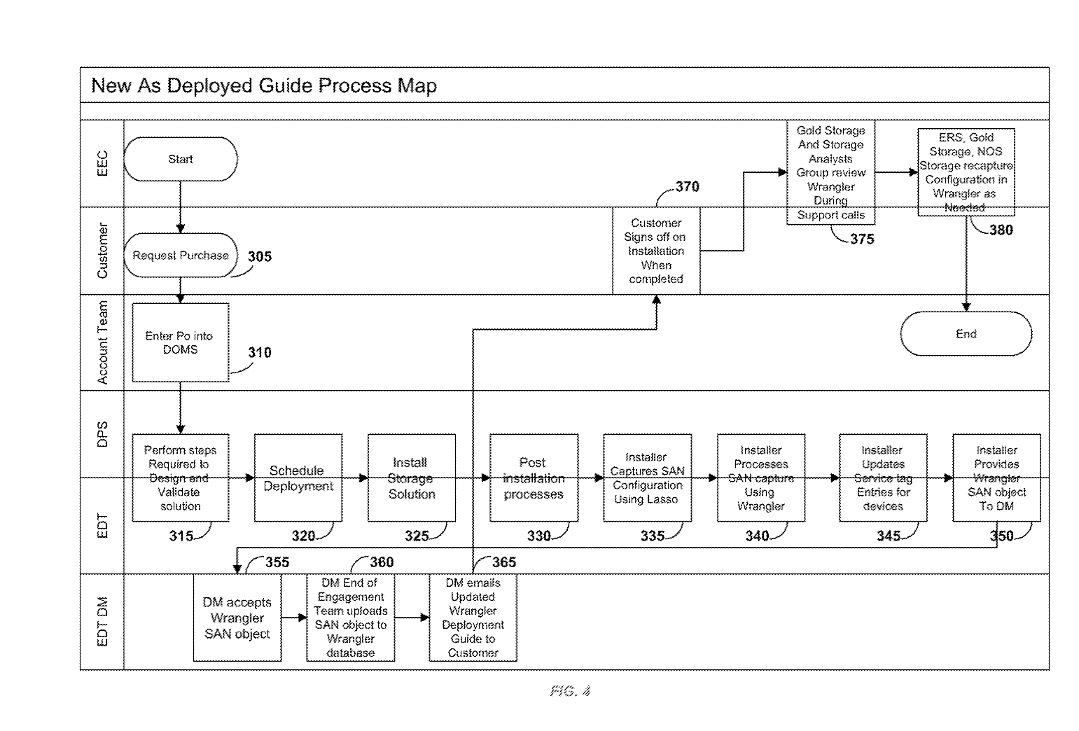

Additionally, the vendor may also encounter a situation where a business would like to create a SAN for the first time. Referring now to FIG. 4 is shown one implementation of a method for installing a SAN. Firsts a new business customer may approach the vendor and requests a purchase 305. The vendor may then enter the purchase order into a sales system 310. The deployment team, field engineers and/or design architects perform steps to design and validate a SAN according to the customer's specifications for capacity and performance 315. Deployment of the SAN is scheduled 320, and the installation of the requested SAN 325 by the deployment team begins at the desired site. Next, the post installation process begins 330. The installer may then run a data collection program 335.

The data collection program may go through an entire SAN and capture the SAN configuration in a snapshot. The data collection program captures the configuration and location of servers, storage arrays tape libraries, fiber channel switches, drivers, application software, storage controllers, and any other elements that may be present in a storage area network. Some of the components may also have a first identifier e.g. service tag, which may indicate a property of the component including, but not limited to, manufacturer of the element and the element type. These service tags may also be gathered by the data collection program.

The data collection program then provides the snapshot and the service tags to a SAN object program 340. The SAN object program uses the snapshot to create a hierarchical or tree view of the SAN configuration. The SAN object program uses service tags to associate them with their respective elements in the tree view, and the installer may update the service tags for elements 345. This data is then stored as a SAN object, which is a smaller representation of the collected data, i.e., it may require less memory in the database than the data in the original form. The data in the snapshot and the service tags may be several hundred megabytes (MB), whereas the stored SAN object is only a few kilobytes (kB). The SAN object may then be provided to a deployment team 350, and the deployment team accepts the SAN object 355 and may review it. The SAN object is uploaded to the vendor's database 360. In illustrative implementations, the SAN object may be stored with a customer order number location data indicating the location of an element, a version number indicating the version of the SAN configuration and/or and a timestamp indicating the date and time of the SAN object is stored. The vendor can use the customer order number to retrieve the SAN configuration from the database.

Continuing with FIG. 4, a deployment guide indicating the configuration of the SAN after the installation is complete may be sent to the customer by a notification such as email or the like 365. After installation is completed, the customer may sign off on the installation 370. Analysts may use the SAN object stored in the database to review the customer's configuration during support calls 375, and the configuration may be recaptured as needed 380.

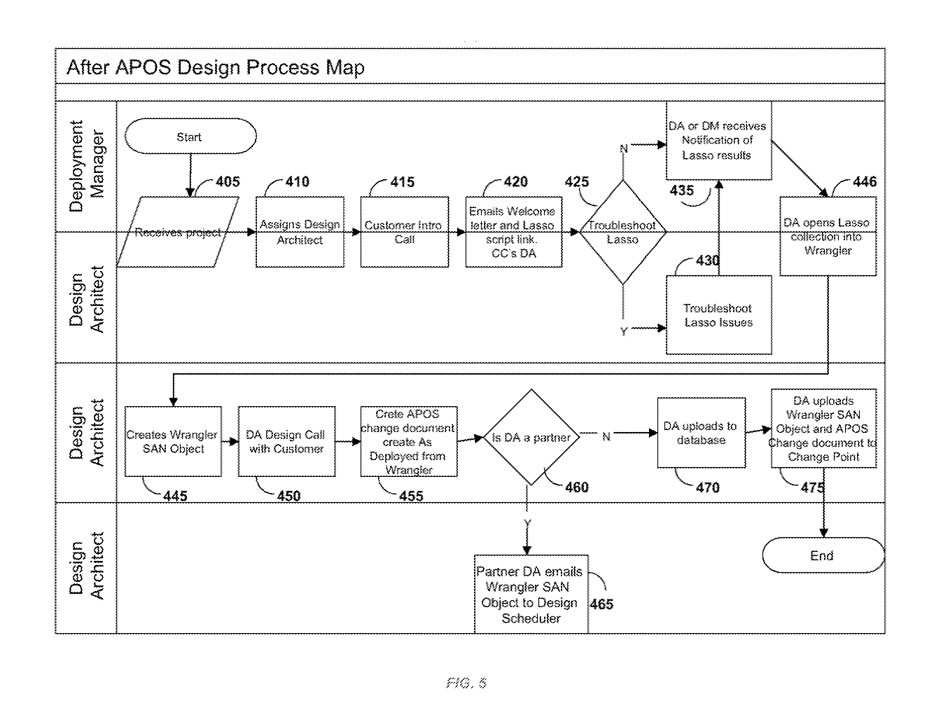

Alternatively, the vendor may encounter a situation where the customer's SAN configuration is stored in the vendor's database from past installations or upgrades, as shown in FIG. 5. When the vendor receives a project 405 to upgrade an existing SAN, a deployment team or the like is assigned to the project 410. The deployment team may contact the customer 415 to determine the desired upgrades in the SAN, and the deployment team may then provide the customer with the data collection program.

While the database may have SAN object stored that indicates the customer's SAN configuration, there may have been changes to the SAN configuration that are not known to the deployment team, i.e., changes to the SAN by the customer or by other vendors. For this reason the data collection program may be provided to the customer to recapture the customer's current SAN configuration. When the data collection program completes and troubleshoots 425 the capture of a snapshot of the customers SAN and service tags, the deployment team is notified and provided with the uploaded results 435. The deployment team provides the snapshot and the service tags to the SAN object program 440, which creates a new SAN object 445.

After review of the SAN object, the deployment team may contact the customer to determine the desired changes to the customer's SAN configuration. Rather than recreating an entire SAN configuration to meet the customers needs, only some changes to the customer's SAN configuration need be made.

The subset of changes may be utilized to create a SAN object change document 455. The SAN object and the SAN object change document may then be uploaded to the database 470. The deployment team is essentially provided with the configuration of the SAN before the desired upgrade and the desired configuration of the SAN after the upgrade 475 allowing the team to provide for the customer's needs in an efficient manner. The SAN object change documents may provide a history of changes to the SAN configuration over time.

As the disclosure above illustrates, SAN configuration capturing systems, apparatus, methods, and processes disclosed may allow a vendor to capture and maintain past, present, and future configurations of a customer's SAN configuration. Additionally, the vendor also has information on the elements or components in the SAN, the location of the elements or components, and the history of changes to the configuration of the SAN. This improves the vendor ability to quickly and easily respond to the customer's request for changes or upgrades to the SAN.

In implementations, part or all of the methods described herein may be described as instructions for an information handling system, and stored on one or more computer readable media or transmitted by a propagated signal. In other illustrative implementations, information handling systems are disclosed which are configured to carry out one or more of the methods described herein, generally by having instructions for the methods stored thereon.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein and/or use of equivalent functional actions for actions described herein. Any insubstantial variations are to be considered within the scope of the claims below.

What is claimed is:

1. A method for handling data within a storage area network (SAN), the method comprising:
receiving by an information handling system, the data from a component of the SAN, the data associated with at least one configuration of the component;
converting the data into processed data; and
providing the processed data to a database.

2. The method of claim 1, wherein the at least one configuration comprises:
a first configuration; and
an upgraded configuration relative to the first configuration.

3. The method of claim 1 further comprising validating the at least one configuration of the component of the SAN.

4. The method of claim 1, further comprising;
providing a first identifier associated with the component of the SAN, wherein the first identifier is combinable with the at least one configuration to generate a solution identifier; and
providing the solution identifier to the database.

5. The method of claim 4, wherein the solution identifier is associated with at least one version number, the at least one version number generated following the step of storing the solution identifier.

6. The method of claim 1, further comprising providing the solution identifier to a user to allow verification of an upgrade to the at least one configuration.

7. A system for handling data in a storage area network (SAN) comprising:
a component of a SAN;
a first program of instructions comprising:
a first instruction to process the data associated with at least one configuration of the component of the SAN into processed data; and
a database operable to receive the processed data associated with the at least one configuration of the component.

8. The system of claim 7, wherein the at least one configuration comprises:
a first configuration; and
an upgraded configuration relative to the first configuration.

9. The system of claim 7, wherein the program of instructions further comprises:
a second program of instructions to receive the data associated with the at least one configuration of the component and store the data at a SAN location.

10. The system of claim 7, wherein the first program of instructions further comprises:
a second instruction to provide a first identifier associated with the component of the SAN, the first identifier combinable with the at least one configuration to generate a solution identifier.

11. The system of claim 10, wherein the solution identifier is associated with at least one version number, the at least one version number being received by the database.

12. A computer-readable medium having executable instructions for performing a method comprising:
receiving, by an information handling system, the data from a component of the SAN, the data associated with at least one configuration of the component;
converting the data into processed data; and
providing the processed data to a database.

13. The medium of claim 12 wherein the at least one configuration comprises:
a first configuration; and
an upgraded configuration relative to the first configuration.

14. The medium of claim 12 further comprising validating the at least one configuration of the component of the SAN.

15. The medium of claim 12 further comprising:
providing a first identifier associated with the component of the SAN, wherein the first identifier is combinable with the at least one configuration to generate a solution identifier; and
providing the solution identifier to the database.

16. The medium of claim 15 wherein the solution identifier is associated with at least one version number, the at least one version number generated following the step of storing the solution identifier.

17. The medium of claim 15 further comprising providing the solution identifier to a user to allow verification of an upgrade to the at least one configuration.
